(19) United States
(12) Patent Application Publication
(10) Pub. No.: US 2012/0303459 A1
(43) Pub. Date: Nov. 29, 2012

(54) METHODS AND APPARATUS FOR COMMUNICATING ADVERTISING CONTROL INFORMATION

(75) Inventors: Arthur Stephens, Hazlet (GB); Ranjith S. Jayaram, Short Hills, NJ (US); Georgios Tsirtsis, London (GB); Vincent D. Park, Budd Lake, NJ (US); Zhibin Wu, Bedminster, NJ (US)

(73) Assignee: QUALCOMM Incorporated, San Diego, CA (US)

(21) Appl. No.: 13/116,964

(22) Filed: May 26, 2011

(51) Int. Cl. G06Q 30/00

(52) U.S. Cl. 705/14.64; 705/14.71

(57) ABSTRACT

Various embodiments are directed to the transmission, e.g., broadcast, of identification information and corresponding control information in discovery signals by a wireless communications device as part of a discovery process. In some embodiments, the identifier identifies one of: an advertisement, a user, or a module. In one embodiment the identifier identifies an advertisement, and the corresponding control information communicates a bid factor used in determining the value of a bid for an ad display opportunity. In another embodiment, the identifier identifies a dynamically modifiable advertisement, and the corresponding control information communicates information that is used to set and/or modify the dynamically modifiable portion of the advertisement. In still another embodiment, the identifier identifiers a user and the control information communicates status information. In yet another embodiment, the identifier identifies a module, e.g., a software application, and the control information communicates a command for the module to perform a particular operation.

### FIELD

Various embodiments relate to wireless communications, and more particularly, to communicating control information, e.g., control information related to advertising, via discovery signaling in a network.

### BACKGROUND

In various wireless systems, devices transmit discovery signals, e.g., identification and/or other discovery information, e.g., as part of a discovery process. Various wireless communications technologies transmit discovery signals sometimes called “expressions” which can be detected by devices in the vicinity of the transmitting device thereby making the receiving device aware of other devices, services, etc. in the area. Expressions are typically used for two purposes: 1) identifying the announcing entity (e.g., application or user), and 2) initiate communications with the announcing entity (e.g., by operating as a paging signal).

The transmitted discovery signals are sometimes called expressions since they communicate or express information. While received expressions provide useful information for various operations, they are often intentionally relatively short and often not sufficient to communicate an entire advertisement. This is because transmitting large amounts of data regularly as part of a peer discovery processes would consume a large amount of resources and potentially delay discovery given the amount of data that would be transmitted if the expressions were allowed to be of a large size, e.g., sufficiently large to communicate an advertisement in the form of an image.

While transmitted expressions may be used to make devices in an area aware of devices, services, stores, etc. which are present or available in an area, conventional peer discovery signals are relatively limited in their usefulness due to their relatively short length. In addition, they tend to be relatively static in nature, e.g., the name of a store or a user identifier normally does not change on an hourly basis.

Entities such as stores offering services or goods for sale find it useful to offer promotions on a short term basis. For example, it might be desirable for a coffee shop to signal a special price or promotion on a short term basis as a function of the number of customers in the coffee shop at a particular point in time. Consider the case where a particular coffee shop owner might want to advertise a special coupon value or deal between 2 and 3 pm while a coffee shop owner corresponding to the same chain that is busy during 2 and 3 pm might not want to offer a similar coupon value or deal.

It would be desirable if methods and/or apparatus could be developed which would allow an entity to communicate or control a promotion through the use of relatively short expressions which could be transmitted as part of a normal discovery process. While not necessary for all embodiments, it would be desirable if expressions used for advertising purposes did not have to communicate the full data needed to generate and display an advertisement.

### SUMMARY

Various embodiments are directed to the transmission, e.g., broadcast, of identification information and corresponding control information in discovery signals as part of a discovery process. The discovery process may be, and sometimes is, part of peer to peer discovery operations performed in a peer to peer wireless communications network.

In some embodiments, the identifier identifies, for example, one of: an advertisement, an advertiser, a store, a user, or a module. In one embodiment, the identifier identifies an advertisement, and the corresponding control information communicates a bid factor used in determining the value of a bid for an ad display opportunity. In another embodiment, the identifier identifies a dynamically modifiable advertisement, and the corresponding control information communicates information that is used to set and/or modify the dynamically modifiable portion of the advertisement. In some embodiments, the identifier identifies an advertisement, and the corresponding control information communicates both: (i) a bid factor used in determining the value of a bid for an ad display opportunity and (ii) information that is used to set and/or modify a dynamically modifiable portion of the advertisement. In still another embodiment, the identifier identifiers a user and the control information communicates status information. In yet another embodiment, the identifier identifies a module, e.g., a software application, and the control information communicates a command instructing the module to perform a particular operation.

In various embodiments the control portion of a transmitted discovery signal is relatively short, e.g., a few bits. In some embodiments the control portion, alone or in combination with a portion used to communicate an identifier, e.g., an ad identifier, is relatively short, e.g., less, and sometimes much less, than the size which would be needed to transmit an image, e.g., the image of the full ad. In some embodiments the control information transmitted in a discovery signal is less than 10 bits.

An exemplary method of operating a wireless communications device, in accordance with some embodiments, comprises: transmitting discovery information including an identifier and transmitting control information corresponding to said identifier. An exemplary wireless communications device, in accordance with some embodiments, comprises: at least one processor configured to: transmit discovery information including an identifier and transmit control information corresponding to said identifier. The exemplary wireless communications device further comprises memory coupled to said at least one processor.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE FIGURES

FIG. 1 is a drawing of an exemplary communications system in accordance with various exemplary embodiments.

FIG. 2 is a flowchart of an exemplary method of operating a wireless communications device in accordance with various embodiments.

FIG. 3 is a drawing of an exemplary wireless communications device in accordance with an exemplary embodiment.

FIG. 4 is an assembly of modules which can, and in some embodiments is, used in the exemplary wireless communications device illustrated in FIG. 3.

FIG. 5 is a drawing of an exemplary peer to peer wireless communication system in accordance with an exemplary embodiment.

FIG. 6 is a drawing of an exemplary peer to peer discovery signal message in accordance with various embodiments.

FIG. 7 is a drawing of an exemplary WiFi beacon signal in accordance with various embodiments.

FIG. 8 includes a drawing of an exemplary advertisement displayed on a wireless communications device and an exemplary discovery information message in accordance with an exemplary embodiment.

FIG. 9 includes a drawing of an exemplary status display of group member status information on a wireless communications device and an exemplary discovery information message in accordance with an exemplary embodiment.

FIG. 10 includes an exemplary discovery information message which may be communicated by a discovery information signal in accordance with an exemplary embodiment.

FIG. 11 includes an exemplary discovery information message which may be communicated by a discovery information signal in accordance with an exemplary embodiment.

### DETAILED DESCRIPTION

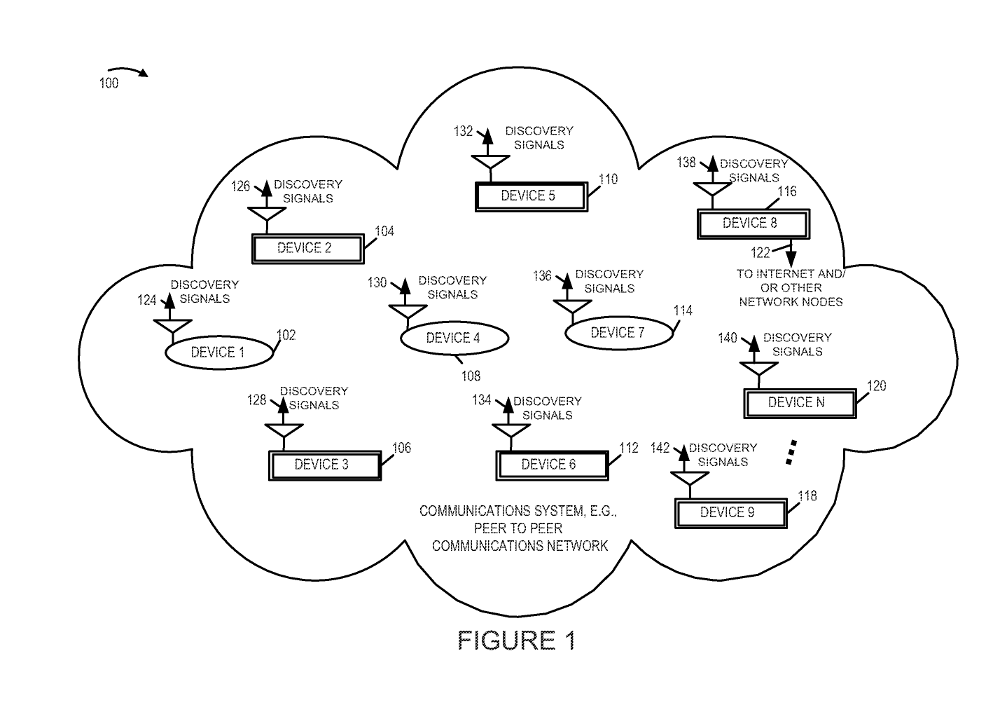

FIG. 1 is a drawing of an exemplary communications system 100, e.g., a peer to peer wireless communications network, in accordance with an exemplary embodiment. Exemplary communications system 100 includes a plurality of wireless communications devices (device 1 102, device 2 104, device 3 106, device 4 108, device 5 110, device 6 112, device 7 114, device 8 116, device 9 118, . . . , device N 120) supporting a peer to peer signaling protocol. Some of the wireless communications devices in system 100 are mobile devices which may move throughout the system 100, while other devices in system 100 are fixed position stationary devices. In this example, wireless communications devices (device 1 102, device 4 108, device 7 114) are mobile devices, while wireless communications devices (device 2 104, device 3 106, device 5 110, device 6 112, device 8 116, device 9 118, device N 120) are stationary devices. Some of the wireless communications devices in system 100 include an interface to a backhaul network which couples the device to the Internet and/or to other network nodes. In this example, wireless communications device 8 116 is coupled to a backhaul network via link 122. In some embodiments, many or most of the wireless communications devices have access to a backhaul network. The access to the backhaul network may be via a wired connection or a non peer to peer wireless connection, e.g., a 3GPPP connection.

The wireless communications devices (102, 104, 106, 108, 110, 112, 114, 116, 118, . . . , 120) generate and transmit, e.g., broadcast, discovery signals (124, 126, 128, 130, 132, 134, 136, 138, 140, . . . , 142), respectively. The discovery signals transmitted from a wireless communications device may be, and sometimes are, detected by other wireless communications devices in its vicinity. The discovery signals convey identification and/or other discovery information. Some discovery signals communicate an identifier, e.g., an identifier used for identification of a device, a user, an advertisement, a service, an application, a software module, hardware module, or a combination software/hardware module. In some embodiments, the discovery signals may, and sometimes do, convey control information related to advertisements, e.g., control information used to determine a bid for display of advertisement, control information used to control the content of a presented advertisement, control information used to set or alter the value of a discount provided as part of an advertisement, control information used to set or alter promotional information presented as part of an advertisement, control information used to select between a plurality of alternative promotional displays within an advertisement, control information used to control content of store customizable field of a chain store advertisement, control information used to communicate a wait time. In some embodiments, the discovery signals may, and sometimes do, convey control information related to an identified user, e.g., control information used to indicate status information, e.g., user availability status and/or application status on the user's device. In some embodiments, the discovery signals may, and sometimes do, communicate control information used to control operation of an identified software module, an identified hardware module, or an identified combination software/hardware module.

In some embodiments, information indicating an identifier and corresponding control information are communicated in the same discovery signal. In some embodiments, information indicating an identifier and corresponding control information are communicated in the same expression conveyed by one or more discovery signals. In various embodiments, the control information portion of a discovery signal is relatively short, e.g., a few bits.

In some embodiments, information indicating an identifier and corresponding control information are communicated in different discovery signals. In some embodiments, information indicating an identifier and corresponding control information are communicated in the different expressions, and each expression can be conveyed by one or more discovery signals.

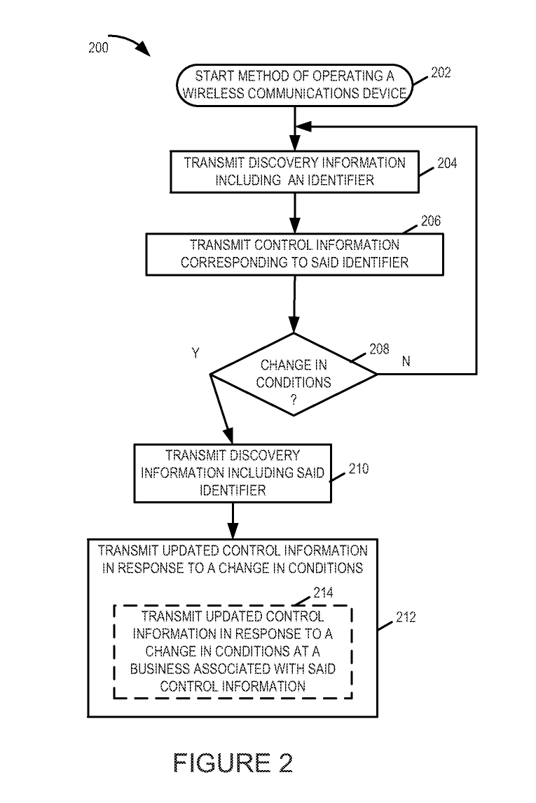

FIG. 2 is a flowchart 200 of an exemplary method of operating a wireless communications device in accordance with various exemplary embodiments. Operation of the exemplary method starts in step 202 where the wireless communications device is powered on and initialized. Operation proceeds from start step 202 to step 204, in which the wireless communications device transmits discovery information including an identifier. In various embodiments, the identifier relates, e.g., corresponds, to one of: an advertisement, an advertiser or a store. In some, but not all embodiments, there is a one to one correspondence between the identifier and the advertisement. In some, but not all embodiments, there is a one to one correspondence between the identifier and the advertiser. In some, but not all embodiments, there is a one to one correspondence between the identifier and the store. Operation proceeds from start step 204 to step 206. In step 206 the wireless communications device transmits control information corresponding to said identifier.

In some embodiments, the control information includes information used by a receiving device to determine an amount bid for display of the advertisement corresponding to said control information. In some embodiments, the control information includes information used to vary an amount of a bid depending on various factors known to the device determining the ad display bid amount at the time the bid is computed. In some such embodiments, the factors include at least one of: geographic location of the device, proximity to a store associated with the advertisement to which the control information corresponds, information about a participant in a loyalty program associated with the advertisement, e.g., whether or not the user of the device is a member of a loyalty program of a store to which an ad relates. In some embodiments, the information used to vary an amount of a bid depending on various factors known to the device determining the ad display bid amount at the time the bid is computed is conveyed in a set of control bits.

In some embodiments, the control information includes information used to control the content of a presented advertisement. In some embodiments, the control information includes information which alters the value of a discount provided as part of the advertisement, e.g., alters the value of discount coupon provided as part of the advertisement.

In some embodiments, the control information includes information which alters the promotional information presented as part of the advertisement. In some such embodiments, the control information includes information which is used to select between a plurality of different promotions associated with an advertisement. In some such embodiments, the control information includes information which selects one of the plurality of promotions which should be displayed as part of an advertisement at a given point in time.

In some embodiments, the advertisement corresponds to a store chain, e.g., Starbucks, and the control information includes control bits which provide information used to control the content of a store customizable field of a store chain advertisement.

Operation proceeds from step 206 to step 208. In step 208 the wireless communications device determines if there has been a change in conditions, e.g., a change in conditions satisfying a predetermined criteria used for determining when to update the transmitted control information. If there has not been a change in conditions, then operation proceeds from step 208 to step 204; otherwise, operation proceeds from step 208 to step 210. In step 210 the wireless communications device transmits discovery information including said identifier.

Operation proceeds from step 210 to step 212. In step 212 the wireless communications device transmits updated control information in response to a change in conditions. In some embodiments, step 212 includes step 214, in which the wireless communications device transmits updated control information in response to a change in conditions at a business associated with said control information. For example, in one embodiment, a store manager is permitted to change, e.g., update, the control information in response to a change in conditions at a business, e.g., a store or service provider. Various exemplary changes in conditions include, e.g., a change in table occupancy at a restaurant, a change in parking space availability at a parking lot, change in the number of customers in a store, a change in current inventory, changes in cash flow in comparison to cash flow thresholds, changes in wait times such as a wait time for a ride at an amusement park, changes in wait times to be seated at a restaurant, changes in wait times to place an order, changes in wait times to be processed through a checkpoint, changes in wait times for customer service, changes in wait times at checkout, changes in wait times at an emergency room, changes in wait times at a doctor's office, changes in wait times at a motor vehicle agency, etc.

In some embodiments, the control information includes control bits which are used to communicate a customer wait time at an individual store for which said control bits are transmitted, and the wait times are displayed as part of an advertisement corresponding to said identifier.

In some embodiments, the identifier transmitted in step 204 corresponds to a user, e.g., a wireless terminal user, instead of a store or business. In some such embodiments, the control information transmitted in step 206 includes status information corresponding to the identified user, and the control information controls a displayed status. In some such embodiments, the status information includes at least one of: user availability information, e.g., user status for communication services, and application status information, e.g., information indicating a set of active applications on a user's device.

In some embodiments, the identifier transmitted in step 204 is a module identifier, and the control information transmitted in step 206 controls an operation performed by a module identified by said module identifier. In some such embodiments, the module corresponds to a software application.

In various embodiments, step 204 and step 206 are performed jointly, e.g., with the identifier and the corresponding control information being transmitted in the same discovery signal. In some such embodiments, steps 210 and 212 are also performed jointly.

In some embodiments, said discovery information including an identifier and said control information corresponding to said identifier are transmitted in a peer discovery message. In some other embodiments, said discovery information including an identifier and said control information corresponding to said identifier are transmitted in a WiFi beacon frame.

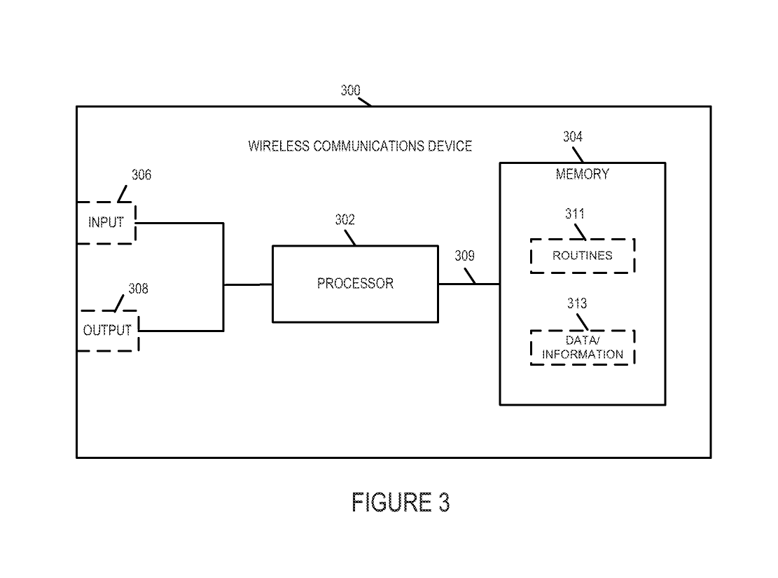

FIG. 3 is a drawing of an exemplary wireless communications device 300 in accordance with an exemplary embodiment. Exemplary wireless communications device 300 is, e.g., one of the wireless communications devices of system 100 of FIG. 1. Exemplary wireless communications device 300 may, and sometimes does, implement a method in accordance with flowchart 200 of FIG. 2.

Wireless device 300 includes a processor 302 and memory 304 coupled together via a bus 309 over which the various elements (302, 304) may interchange data and information. Wireless communications device 300 further includes an input module 306 and an output module 308 which may be coupled to processor 302 as shown. However, in some embodiments, the input module 306 and output module 308 are located internal to the processor 302. Input module 306 can receive input signals. Input module 306 can, and in some embodiments does, include a wireless receiver and/or a wired or optical input interface for receiving input. Output module 308 may include, and in some embodiments does include, a wireless transmitter and/or a wired or optical output interface for transmitting output. In some embodiments, memory 304 includes routines 311 and data/information 313.

In some embodiments, processor 302 is configured to: transmit discovery information including an identifier and transmit control information corresponding to said identifier. In various embodiments, said identifier relates, e.g., corresponds, to one of: an advertisement, and advertiser or a store.

In some embodiments, the control information includes information used by a receiving device to determine an amount bid for display of the advertisement corresponding to said control information. In various embodiments, said control information includes information used to vary an amount of a bid depending on various factors known to the device determining the ad display bid amount at the time the bid is computed. The factors includes, e.g., at least one of: geographic location of the device, proximity to a store associated with the advertisement to which the control information corresponds, information about participation in a loyalty program associated with the advertisement, e.g., user of device is member of loyalty program of store to which an ad relates.

In some embodiments, said control information includes information used to control the content of a presented advertisement. In various embodiments, said control information includes information which alters the value of a discount, e.g., the value of a discount coupon, provided as part of the advertisement.

In some embodiments, said control information includes information which alters the promotional information presented as part of the advertisement. In some embodiments, said control information includes information which is used to select between a plurality of different promotions associated with an advertisement. In some such embodiments, said control information includes information which is used to select which one of the plurality of promotions should be displayed as part of an advertisement at a given point in time.

In some embodiments, said advertisement corresponds to a chain store, e.g., Starbucks; and said control information includes control bits which provide information used to control the content of a store customizable field of a chain store advertisement.

In some embodiments, processor 302 is further configured to transmit updated control information in response to a change in conditions. In some embodiments, processor 302 is configured to transmit updated control information in response to a change in conditions at a business, e.g., a store or service provider, associated with said control information, e.g., in response to a change in table occupancy, a change in current inventory, a change in cash flow threshold, and/or a change in wait times. Exemplary wait times include, e.g., wait times to get through a checkout, wait times to get served, emergency room wait times, doctor's office wait times, motor vehicle service wait times, etc.

In some embodiments, said control information includes control bits which are used to communicate a customer wait time at an individual store from which said control bits are transmitted, and the processor 302 is configured to display the wait time as part of an advertisement corresponding to said identifier.

In some embodiments, the identifier included in the transmitted discovery information corresponds to a store or business. In some embodiments, the identifier included in the transmitted discovery information corresponds to a user, e.g., a WT user. In some such embodiments, said control information indicates status information corresponding to the identified user, said control information controlling a displayed status. In some such embodiments, said status information includes at least one of: user availability information, e.g., user status for communication services, and application status information, e.g., information indicating a set of active applications on a user's device.

In some embodiments said identifier included in the transmitted discovery information is a module identifier, and said control information controls an operation performed by a module identified by said module identifier. In some such embodiments, said module corresponds to a software application.

In some embodiments, processor 302 is configured to transmit said discovery information including an identifier and said control information corresponding to said identifier in a peer discovery message. In some other embodiments, processor 302 is configured to transmit said discovery information including an identifier and said control information corresponding to said identifier in a WiFi beacon frame.

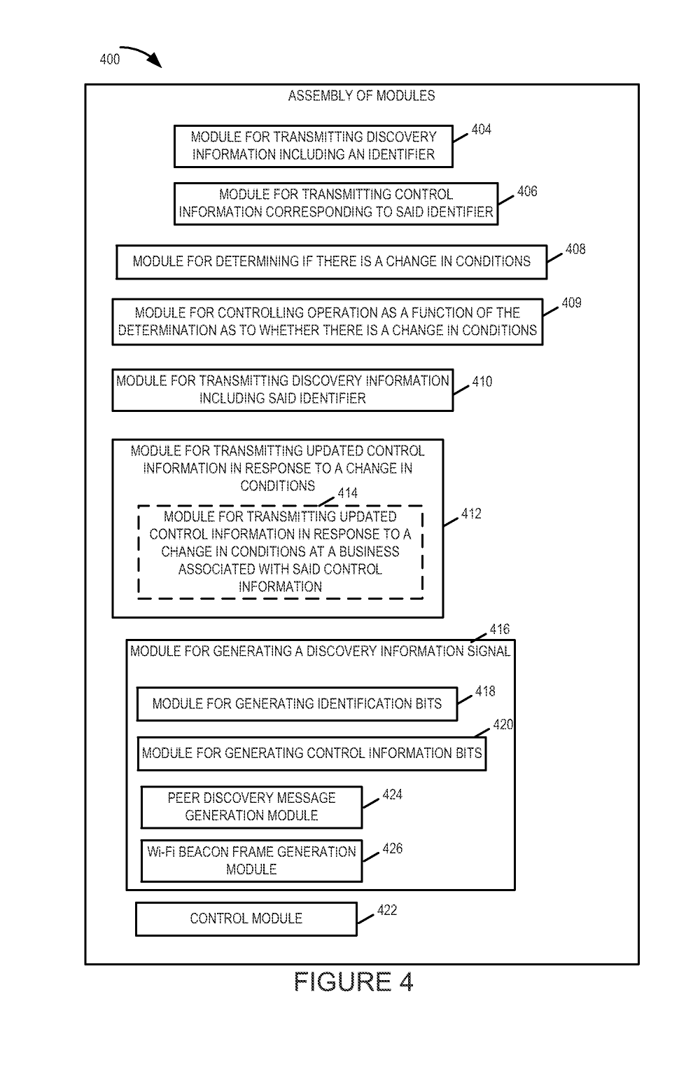

FIG. 4 is an assembly of modules 400 which can, and in some embodiments is, used in the exemplary wireless communications device 300 illustrated in FIG. 3. The modules in the assembly 400 can be implemented in hardware within the processor 302 of FIG. 3, e.g., as individual circuits. Alternatively, the modules may be implemented in software and stored in the memory 304 of wireless communications device 300 shown in FIG. 3. In some such embodiments, the assembly of modules 400 is included in routines 311 of memory 304 of device 300 of FIG. 3. While shown in the FIG. 3 embodiment as a single processor, e.g., computer, it should be appreciated that the processor 302 may be implemented as one or more processors, e.g., computers. When implemented in software the modules include code, which when executed by the processor, configure the processor, e.g., computer, 302 to implement the function corresponding to the module. In some embodiments, processor 302 is configured to implement each of the modules of the assembly of modules 400. In embodiments where the assembly of modules 400 is stored in the memory 304, the memory 304 is a computer program product comprising a computer readable medium, e.g., a non-transitory computer readable medium, comprising code, e.g., individual code for each module, for causing at least one computer, e.g., processor 302, to implement the functions to which the modules correspond.

Completely hardware based or completely software based modules may be used. However, it should be appreciated that any combination of software and hardware (e.g., circuit implemented) modules may be used to implement the functions. As should be appreciated, the modules illustrated in FIG. 4 control and/or configure the wireless communications device 300 or elements therein such as the processor 302, to perform the functions of the corresponding steps illustrated and/or described in the method of flowchart 200 of FIG. 2.

Assembly of modules 400 includes a module 404 for transmitting discovery information including an identifier, a module 406 for transmitting control information corresponding to said identifier, a module 408 for determining if there is a change in conditions, a module 409 for controlling operation as a function of the determination as to whether there is a change in conditions, a module 410 for transmitting discovery information including said identifier, and a module 412 for transmitting control information in response to a change in conditions. In some embodiments, module 412 includes a module 414 for transmitting updated control information in response to a change in conditions at a business associated with said control information.

Assembly of modules 400 further includes a module 416 for generating a discovery information signal and a control module 422. Module 418 further includes a module 418 for generating identification bits to convey an identifier, e.g., an ad identifier, a user identifier, or a module identifier, and a module 420 for generating control information bits 420. The generated control information bits from module 420 correspond to the identifier from module 418. Control module 422 controls the apparatus, e.g., wireless communications device 300, to perform one or more additional steps or functions in accordance with various aspects and/or features.

Module 416 includes a peer discovery message generation module 424 and a Wi-Fi beacon frame generation module 426. In some embodiments, module 416 generates a peer discovery message signal. In some embodiments, module 416 generates a Wi-Fi beacon frame signal.

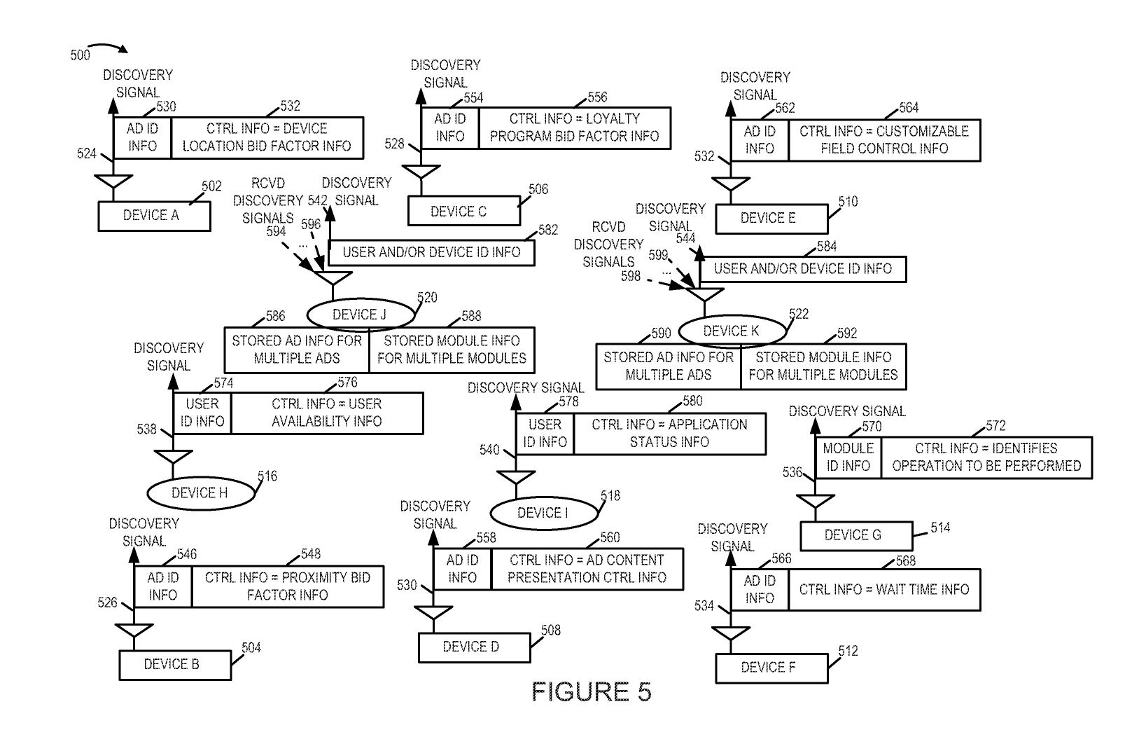

FIG. 5 is a drawing of an exemplary peer to peer wireless communication system 500 in accordance with an exemplary embodiment. In wireless peer to peer wireless communications system 500, the wireless communications devices (device A 502, device B 504, device C 506, device D 508, device E 510, device F 512, device G 514, device H 516, device I 518, device J 520, device K 522) implement a peer to peer signaling protocol including a recurring peer to peer timing structure including discovery signaling interval. During the discovery signaling interval, devices broadcast peer to peer discovery signals and listen for peer to peer discovery signals from other devices. At least some of the peer to peer discovery signals communicate an identifier and control information corresponding to the identifier. The identifier is, e.g., one of an identifier corresponding to an advertisement, e.g., an advertisement that can be displayed on a wireless communications device, an identifier corresponding to a user, an identifier corresponding to a device, and an identifier corresponding to a module, e.g., a module corresponding to a software application resident on a wireless communications device.

Wireless communications devices (502, 504, 506, 508, 510, 512, 514, 516, 518, 520, 522) transmit, e.g., broadcast, discovery signals (524, 526, 528, 530, 532, 534, 536, 538, 540, 542, 544), respectively. Peer to peer discovery signal 524 includes advertisement identification information 530 identifying a particular advertisement that may be stored in and displayed on a wireless communications device and control information 532 indicating a device location bid factor corresponding to the identified advertisement. Peer to peer discovery signal 526 includes advertisement identification information 546 identifying a particular advertisement that may be stored in and displayed on a wireless communications device and control information 548 indicating a proximity bid factor corresponding to the identified advertisement. Peer to peer discovery signal 528 includes advertisement identification information 554 identifying a particular advertisement that may be stored in and displayed on a wireless communications device and control information 556 communicating loyalty program bid factor information corresponding to the identified advertisement.

Peer to peer discovery signal 530 includes advertisement identification information 558 identifying a particular advertisement that may be stored in and displayed on a wireless communications device and control information 560 communicating advertisement content presentation control information corresponding to the identified advertisement. Peer to peer discovery signal 532 includes advertisement identification information 562 identifying a particular advertisement that may be stored in and displayed on a wireless communications device and control information 564 communicating advertisement control information for a customizable field corresponding to the identified advertisement. Peer to peer discovery signal 534 includes advertisement identification information 566 identifying a particular advertisement that may be stored in and displayed on a wireless communications device and control information 568 communicating wait time information corresponding to the identified advertisement.

Peer to peer discovery signal 536 includes module identification information 570 identifying a particular module, e.g., a module corresponding to a software application, that may be included within a wireless communications device and control information 572 communicating a control operation to be performed by the identified module, e.g., commanding one of a plurality of alternative control operations to be performed by the identified module. Peer to peer discovery signal 538 includes user identification information 574 identifying the user of wireless communications device H 516 and control information 576 communicating availability information corresponding to the identified user. Peer to peer discovery signal 540 includes user identification information 578 identifying the user of wireless communications device I 518 and control information 580 communicating application status information corresponding to one or more applications resident on device 1518.

Peer to peer discovery signal 542 includes user and/or device identification information 582 corresponding to device J 520 and/or the user of device J 520. Peer to peer discovery signal 544 includes user and/or device identification information 584 corresponding to device K 522 and/or the user of device K 522.

Device J 520 includes stored advertisement information for multiple ads 586, e.g., a set of advertisement corresponding to each of a plurality of ads which may be displayed on device J to a user of device J at an ad display opportunity. Device J also includes stored module information for multiple modules 588, e.g., a set of module information corresponding to each of a plurality of modules where each module in said plurality of modules corresponds to a different software application. Device K 522 includes stored advertisement information for multiple ads 590, e.g., a set of advertisement corresponding to each of a plurality of ads which may be displayed on device K to a user of device K at an ad display opportunity. Device K also includes stored module information for multiple modules 592, e.g., a set of module information corresponding to each of a plurality of modules where each module corresponds to a different software application. The ad to be displayed, at a particular display opportunity, by exemplary devices (device J 520, device K 522) may be, and sometimes is, determined as a function of control information received in discovery signals from other wireless communications devices. The content of the ad being displayed by exemplary devices (device J 520, device K 522) may be, and sometimes is, determined as a function of control information received in discovery signals from other wireless communications devices. Status information displayed by devices (device J 520, device K 522) may be, and sometimes is, received in discovery signals from other wireless communications devices.

Device J 520 receives peer discovery signals, which were broadcast from other wireless communications devices, as indicated by exemplary received discovery signals (594, . . . , 596). Received discovery signals (594, . . . , 596) are received signals corresponding to one or more or all of transmitted discovery signals (524, 526, 528, 530, 532, 534, 536, 538, 540, 544). Device K 522 receives peer discovery signals, which were broadcast from other wireless communications devices, as indicated by exemplary received discovery signals (598, . . . , 599). Received discovery signals (598, . . . , 599) are received signals corresponding to one or more or all of transmitted discovery signals (524, 526, 528, 530, 532, 534, 536, 538, 540, 542).

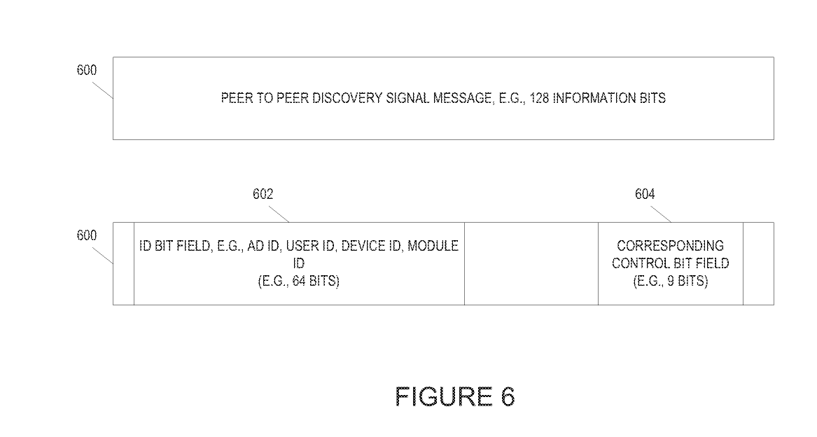

FIG. 6 is a drawing of an exemplary peer to peer discovery signal message 600 in accordance with various embodiments. Exemplary discovery signal message 600 is, e.g., communicated via a discovery signal, e.g., a discovery signal generated by wireless communications device 300 and transmitted, e.g., broadcast, by wireless communications device 300, and/or generated and transmitted by a wireless communications device implementing a method in accordance with flowchart 200 of FIG. 2. Exemplary peer to peer discovery signal message 600 conveys, e.g., 128 information bits. Peer to peer discovery signal message 600 includes an identification bit field 602 and a corresponding control bit field 604. The ID bit field 602, e.g., a 64 bit field, communicates an identifier, e.g., an ad identifier, a user identifier, or a module identifier. The corresponding control bit field bit 604, e.g., a 9 bit field, communicates control information, e.g., control information used to influence a bid for an auction for an ad display opportunity, control information used to customize an ad, control information used to select between a plurality of predetermined alternative variations of an ad, control information used to vary a small portion of an ad, control information used to communicate information to be displayed in a portion of an ad, e.g., a wait time, a price, a coupon, a daily special, a manager special, a limited time offer, etc., control information used to communicate user status information to be displayed as part of a larger status display, e.g., current status of members of a group, current status of applications on a device, etc., or control information used to control an identified module to perform one of a plurality of predetermined operations. In various embodiments, the control bit field has a relatively small number of bits, e.g., substantially less bits than the bits needed to communicate the image for the full ad that is being displayed.

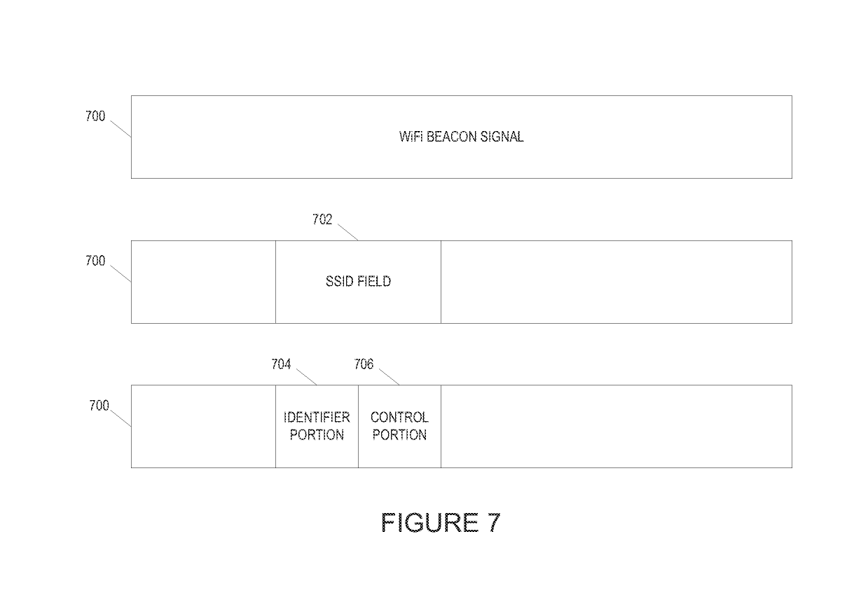

FIG. 7 is a drawing of an exemplary WiFi beacon signal 700 in accordance with various embodiments. Exemplary WiFi beacon signal 700 is, e.g., a discovery signal generated by wireless communications device 300 and transmitted, e.g., broadcast, by wireless communications device 300 and/or generated and transmitted by a wireless communications device implementing a method in accordance with flowchart 200 of FIG. 2. WiFi beacon signal 700 includes an SSID field 702. The SSID field 702 includes an identifier portion 704 and a corresponding control portion 706. Identifier portion 704 communicates the same type of information as ID bit field 602; control portion 706 communicates the same type of information as control bit field 604.

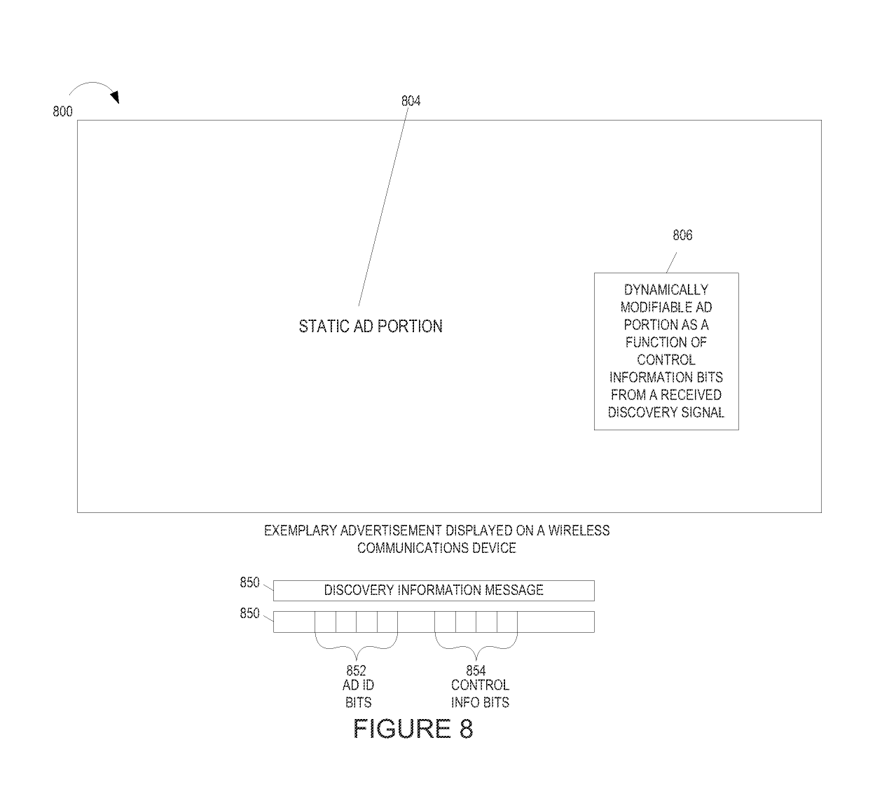

FIG. 8 includes a drawing of an exemplary advertisement 800 displayed on a wireless communications device and an exemplary discovery information message 850 in accordance with an exemplary embodiment. The exemplary advertisement 800 displayed on a wireless communications device includes a static ad portion 804 and a dynamically modifiable ad portion which can be, and sometimes is, varied, as a function of control information bits received in a discovery signal, e.g., a peer discovery broadcast signal. Exemplary discovery information message 850, which is carried by a discovery information signal, includes ad identification bits 852, which communicate an ad identifier corresponding to a particular ad, and control information bits 854, which convey control information used to control the display of the dynamically modifiable ad portion in the ad identified by the ad identifier communicated by bits 852. In some embodiments, control information bits 854 selects one of a plurality of predetermined alternative displays to be placed in the dynamically modifiable ad portion. In some embodiments, the control information bits communicate a wait time, e.g., a restaurant wait time to be seated. In some embodiments, the control information bits communicate a coupon or portion of a coupon. In some embodiments, the control information bits communicate a special offer from an individual store in a chain of stores, e.g., a store manager special offer. In some embodiments, the control information bits communicate a price, e.g., different stores in a franchise may have slightly different pricing in an ad, e.g., as a function of location. In some embodiments, the control information bits communicate or identify information mandated to be placed in an ad by a governmental agency or law, e.g., different states or cities may have different requirements.

In some embodiments, the dynamically modifiable portion of the ad includes non-contiguous portions. In some embodiments, the dynamically modifiable portion of the ad includes the display of a person, e.g., an ad spokesperson may be selected from among a plurality of predetermined alternatives. In some embodiments, the selection of the ad spokesperson is determined to target a particular customer group or category, e.g., a particular age group, e.g., as a function of measured or estimated traffic statistics, e.g., at different times of a day different age groups may be in a mall. In some embodiments, the dynamically modifiable portion of the ad includes the display of a product, e.g., a product may be selected from among a plurality of predetermined alternatives, e.g., a hamburger, a chicken sandwich, or a fish sandwich may be selected to be displayed, e.g., to attempt to increase sales to balance current inventory, to increase profits, and/or in response to detected competitor activity.

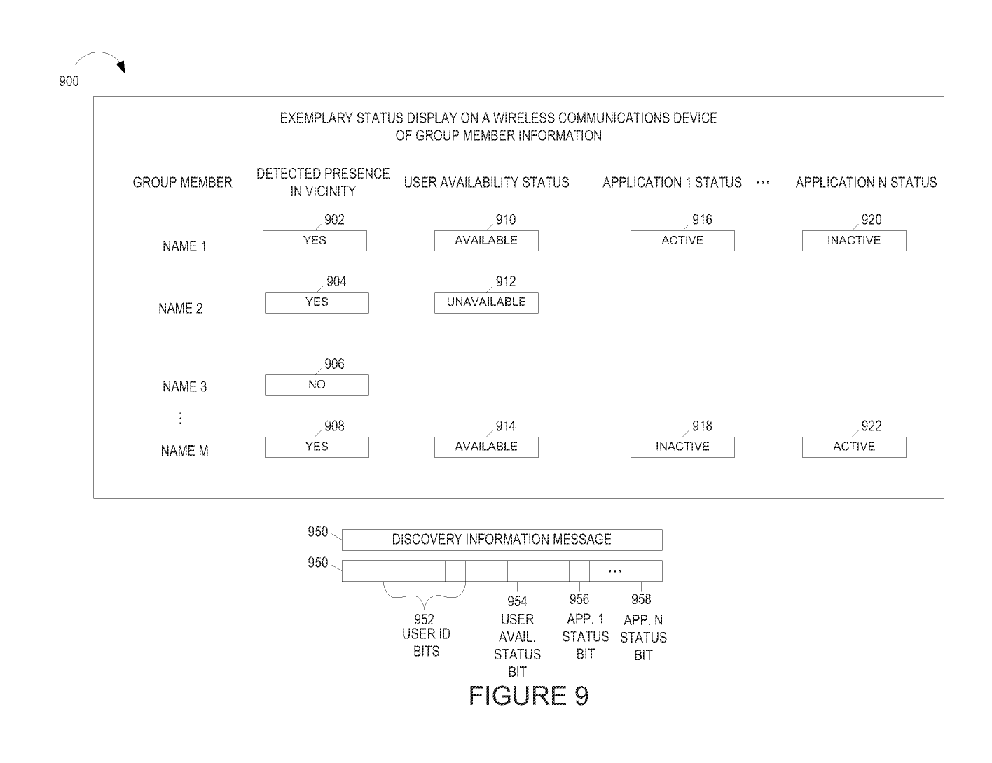

FIG. 9 includes a drawing of an exemplary status display of group member status information 900 on a wireless communications device and an exemplary discovery information message 950 in accordance with an exemplary embodiment. Status display 900 includes a list of group members (name 1, name 2, name 3, . . . , name M) which belong to the same group as the user of the wireless communications device on which display 900 appears. Status display 900 includes a column identifying whether a group member user's presence has been detected, a column indicating user availability status corresponding to each detected member, and columns indicating status corresponding to each of a plurality of applications (application 1 status, . . . , application N status).

Exemplary discovery information message 950, which is carried by a discovery information signal, includes user identification bits 952, which communicate a user identifier, e.g., which may and sometimes do correspond to a group member name. Discovery information message 950 also includes a plurality of control information bits corresponding to the user ID bits 952. The control information bits include a user availability status bit 954, and a plurality of application status bits (application 1 status bit 956, . . . , application N status bit 958). In this example, consider that the wireless communications device displaying status display 900 to its user, has detected and recovered discovery information signals from devices with user IDs corresponding to name 1, name 2, and name M. Therefore in the column indicating detected presence, information field 902 is set to YES for name 1, information field 904 is set to YES for name 2, information field 906 is set to NO for name 3, and information field 908 is set to YES for name M. Each discovery information message, communicated in a discovery signal, communicated user availability status information and application status information. In this example, the discovery message transmitted from the user corresponding to name 1 indicated that the user is currently available, that application 1 is active and application N is inactive; the communicated information is recovered and displayed as indicated by fields (910, 916, 920), respectively. In this example, the discovery message transmitted from the user corresponding to name 2 indicated that the user is currently unavailable; the communicated information is recovered and displayed as indicated by field 912. In this example, the discovery message transmitted from the user corresponding to name M indicated that the user is currently available, that application 1 is inactive and application N is active; the communicated information is recovered and displayed as indicated by fields (914, 918, 922), respectively.

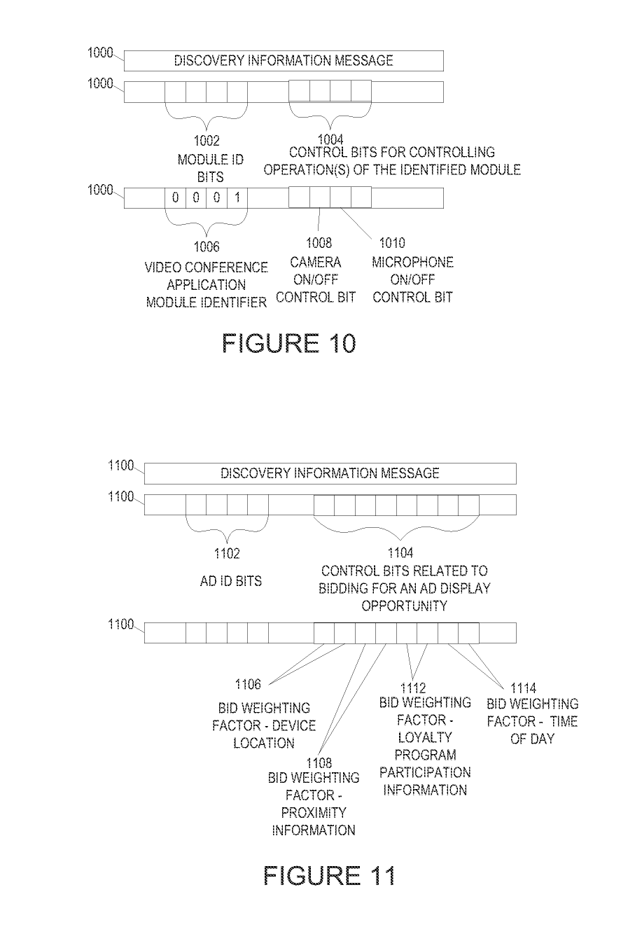

FIG. 10 includes an exemplary discovery information message 1000 which may be communicated by a discovery information signal in accordance with an exemplary embodiment. Exemplary discovery information message 1000 includes a module identification bit field 1002, e.g., for identifying one of a plurality of alternative modules, e.g., software applications, which may be selected and controlled. Exemplary discovery information message 1000 also includes a control information bit field 1004 for communicating control information for controlling operations of the module identified by the information communicated in the module ID bits 1002. In one example, the bit pattern=0001 in module ID bit field 1002 identifies that a video conference application module has been selected 1006. The control information bits 1004 include a camera on/off control bit 1008 and a microphone on/off control bit 1010.

FIG. 11 includes an exemplary discovery information message 1100 which may be communicated by a discovery information signal in accordance with an exemplary embodiment. Exemplary discovery information message 1100 includes an ad identification bit field 1102, e.g., for identifying one of a plurality of alternative ads which may be stored on a wireless communications device. In some embodiments, within the wireless communications device there are auctions for ad display opportunities. Exemplary discovery information message 1100 also includes a control information bit field 1104 for communicating control information related to bidding for an ad display opportunity. The control information bit field 1104 includes: bits 1106 for communicating a bid weighting factor used in determining the bid as a function of the geographic location of the device which is to display the ad, bits 1108 for communicating a bid weighting factor used in determining the bid as a function of the proximity of the device which is to display the ad to the device which transmitted the discovery information message, bits 1112 for communicating a bid weighting factor used in determining the bid as a function of participation in a loyalty program, and bits 1114 for communicating a bid weighting factor used for determining a bid as a function on the time of day.

Various features and/or aspects of some, but not necessarily all, embodiments, are further described below. In some embodiments, an ad identifier and control information corresponding to the identified ad is communicated via wireless signaling, e.g., via one or more broadcast discovery signals. In some embodiments, the ad identifier and control information are communicated in the same broadcast discovery signal. In some embodiments, the ad identifier and corresponding control information are communicated in different broadcast discovery signals; however, there is a known or determinable linkage between the ad identification information and corresponding ad control information.

In various embodiments some wireless communications devices control ads displayed on other wireless communications devices. Some exemplary wireless communications devices which control the display of ads on other devices are sometimes referred to as “AdPoint” devices. One exemplary such device is a fixed location AdPoint device corresponding to a store. Exemplary wireless communications device 300 of FIG. 3 which supports a peer to peer signaling protocol is, e.g., an AdPoint device. An exemplary wireless communications device, which displays ads which are controlled by other devices is, e.g., a mobile wireless communications device which receives broadcast discovery signals from an AdPoint device. Exemplary mobile wireless communications device J 520 of FIG. 5 which supports a peer to peer signaling protocol is such a device.

In some embodiments a broadcast signal conveying an ad identifier and corresponding ad control information is a peer discovery signal in an exemplary peer to peer signaling protocol including a recurring peer to peer timing structure including peer discovery intervals. In some embodiments the broadcast signal conveying the ad identifier and corresponding ad control information is a WiFi beacon signal which communicate discovery information. In some embodiments, a signal communicating the ad identification information and ad control information is transmitted on a periodic or predictable basis.

A device, e.g., an AdPoint, transmitting the ad identification information and control information may, and sometimes does, change the control information over time, e.g., in response to a change in conditions. The ad information identifying an advertisement to be displayed, in some embodiments, identifies a dynamically modifiable advertisement to be displayed, and the control information corresponding to the identified advertisement to be displayed controls the display, e.g., allowing the ad display to be modified in response to changes in the transmitted control information.

In some embodiments, a broadcast discovery signal includes a predetermined number of “control bits” used for control related to an identified ad. The number of control bits used depends on the particular implementation. The number of control bits used is different for different implementations, e.g., based on tradeoffs considerations between expressive power and efficient use of broadcast channel resources. In some embodiments the number of control bits is considerable less than the number of bits that would be used to communicate the content of the advertisement. In some such embodiments, the number of ad control bits in a discovery signal is less than 10 bits.

Some exemplary uses of ad control bits include controlling bidding for an ad display opportunity in a wireless communications device and controlling the content of a displayed dynamically modifiable ad in a wireless communications device.

In one example, a store indicates using ad control bits communicated in a discovery signal that it is close to being empty. The store may have an executable program, called a “bid script” containing bidding logic defined by the store stored on the receiving device. The store's bid script on devices that receive this information increases the bid placed for the store's ad in an auction for an ad display opportunity, in response to the received ad control bits indicating an almost empty store. This increases the chance that the store's ad wins ad display opportunity auctions on mobile wireless communications devices. This in turn increases the likelihood that the store will succeed in attracting more customers to the store.

In another example, the ad control bits are used to determine the content of an identified ad that is presented at a presentation opportunity. For example, a restaurant may indicate the lunch discount amount of the day in its control bits. The restaurant's ad generation executable program on devices can generate a dynamic image that shows the discount amount and embed the image in the restaurant's ad. Control bits thus allow ads to be dynamic and respond to changing external situations.

In various embodiments, a discovery signal communicates an expression. In some such embodiments the expression includes an identification portion and a control portion. The identifier portion includes, e.g., an expression code+discriminator. This identifier portion identifies an ad, e.g., an ad corresponding to a store such as Starbucks, McDonalds, etc. The control portion includes control information corresponding to the identified ad identifier by the identifier portion. In some embodiments, the control portion facilitates dynamic modification of the identified ad.

An exemplary expression structure, in some embodiments, includes: a unique or group identification (static)+Optional unique discriminator (semi-static)+Optional control data (dynamic). In some embodiments, when control data is part of a public expression it is public and can be decoded by each of the receiving devices. In some embodiments public expressions are also known as direct expression (DEXP). In some embodiments, when control data is part of a private expression it can be decoded only by devices that are authorized to receive and decode the private expression, e.g., by devices that have a secret key known to the transmitter of the expression and the devices that are authorized to receive and decode the expression. In some embodiments, private expressions are also known as hashed expressions (HEXP). Typically, receiving devices know the static (identification) part they wish to monitor. The discriminator and control data are not known in advance and are discovered during the monitoring process. In some embodiments, control data can be of at least two types:
1. Descriptive data, which are metadata associated with the entity announcing the expression. An example is an expression whose identification portion includes a user's expression-code and control part includes the user's status on an instant messaging application.
2. Prescriptive data, which are instructions meant for entities that receive the expression. An example is control bits announced by an “AdPoint” corresponding to an identified ad that controls how bids for the identified ad are placed on devices that receive the expression.

In some embodiments, the control bits are included in the same broadcast discovery signal with corresponding identification information used to identify an ad, user, module, etc. In some other embodiments, the identifier information and corresponding control information are communicated in different broadcast discovery signals. In some exemplary embodiments the broadcast discovery signal communicating the identifier, e.g. ad identifier, and corresponding control information, e.g., ad control information, is a peer discovery signal communicated during a peer discovery interval in a recurring peer to peer timing structure. In some WiFi embodiments, the broadcast discovery signal is a WiFi beacon signal in which the SSID field in the beacon has been split to include an identifier portion and a control portion.

In various embodiments a device, e.g., a wireless communications in system 100 of FIG. 1, wireless communication device 300 of FIG. 3, and/or a wireless communications device in system 500 of FIG. 5, includes a module corresponding to each of the individual steps and/or operations described with regard to any of the Figures in the present application and/or described in the detailed description of the present application. The modules may, and sometimes are implemented in hardware. In other embodiments, the modules may, and sometimes are, implemented as software modules including processor executable instructions which when executed by the processor of the communications device cause the device to implement the corresponding step or operation. In still other embodiments, some or all of the modules are implemented as a combination of hardware and software.

The techniques of various embodiments may be implemented using software, hardware and/or a combination of software and hardware. Various embodiments are directed to apparatus, e.g., network nodes, mobile nodes such as mobile terminals, access points such as base stations, and/or communications systems. Various embodiments are also directed to methods, e.g., method of controlling and/or operating network nodes, mobile nodes, access points such as base stations and/or communications systems, e.g., hosts. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In various embodiments nodes described herein are implemented using one or more modules to perform the steps corresponding to one or more methods, for example, signal processing, signal generation and/or transmission steps. Thus, in some embodiments various features are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., communications node, including a processor configured to implement one, multiple or all of the steps of one or more methods of the invention.

In some embodiments, the processor or processors, e.g., CPUs, of one or more devices, e.g., communications nodes such as network nodes, access nodes and/or wireless terminals, are configured to perform the steps of the methods described as being performed by the communications nodes. The configuration of the processor may be achieved by using one or more modules, e.g., software modules, to control processor configuration and/or by including hardware in the processor, e.g., hardware modules, to perform the recited steps and/or control processor configuration. Accordingly, some but not all embodiments are directed to a device, e.g., communications node, with a processor which includes a module corresponding to each of the steps of the various described methods performed by the device in which the processor is included. In some but not all embodiments a device, e.g., communications node, includes a module corresponding to each of the steps of the various described methods performed by the device in which the processor is included. The modules may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g. one or more steps described above. Depending on the embodiment, the computer program product can, and sometimes does, include different code for each step to be performed. Thus, the computer program product may, and sometimes does, include code for each individual step of a method, e.g., a method of controlling a communications device or node. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device or other device described in the present application.

Various embodiments are well suited to communications systems using a peer to peer signaling protocol. Some embodiments use an Orthogonal Frequency Division Multiplexing (OFDM) based wireless peer to peer signaling protocol, e.g., WiFi signaling protocol or another OFDM based protocol.

While described in the context of an OFDM system, at least some of the methods and apparatus of various embodiments are applicable to a wide range of communications systems including many non-OFDM and/or non-cellular systems.

Numerous additional variations on the methods and apparatus of the various embodiments described above will be apparent to those skilled in the art in view of the above description. Such variations are to be considered within the scope. The methods and apparatus may be, and in various embodiments are, used with Code Division Multiple Access (CDMA), OFDM, and/or various other types of communications techniques which may be used to provide wireless communications links between communications devices. In some embodiments one or more communications devices are implemented as access points which establish communications links with mobile nodes using OFDM and/or CDMA and/or may provide connectivity to the internet or another network via a wired or wireless communications link. In various embodiments the mobile nodes are implemented as notebook computers, personal data assistants (PDAs), or other portable devices including receiver/transmitter circuits and logic and/or routines, for implementing the methods.

What is claimed is:

1. A method of operating a wireless communications device, the method comprising:
transmitting discovery information including an identifier; and
transmitting control information corresponding to said identifier.

2. The method of claim 1, wherein said identifier relates to one of: an advertisement, an advertiser or a store.

3. The method of claim 2, wherein said control information includes information used by a receiving device to determine an amount bid for display of the advertisement corresponding to said control information.

4. The method of claim 3, wherein said control information includes information used to vary an amount of a bid depending on various factors known to the device determining the ad display bid amount at the time the bid is computed.

5. The method of claim 4, wherein said factors includes at least one of: geographic location of the device, proximity to a store associated with the advertisement to which the control information corresponds, information about participation in a loyalty program associated with the advertisement.

6. The method of claim 2, wherein said control information includes information used to control the content of a presented advertisement.

7. The method of claim 6, wherein said control information includes information which alters the promotional information presented as part of the advertisement.

8. The method of claim 7, wherein said control information includes information which is used to select between a plurality of different promotions associated with an advertisement.

9. The method of claim 8,
wherein said advertisement corresponds to a chain store; and
wherein said control information includes control bits which provide information used to control the content of a store customizable field of a chain store advertisement.

10. A wireless communications device comprising:
means for transmitting discovery information including an identifier; and
means for transmitting control information corresponding to said identifier.

11. The wireless communications device of claim 10, wherein said identifier relates to one of: an advertisement, an advertiser or a store.

12. The wireless communications device of claim 11, wherein said control information includes information used by a receiving device to determine an amount bid for display of the advertisement corresponding to said control information.

13. The wireless communications device of claim 12, wherein said control information includes information used to vary an amount of a bid depending on various factors known to the device determining the ad display bid amount at the time the bid is computed.

14. The wireless communications device of claim 13, wherein said factors includes at least one of: geographic location of the device, proximity to a store associated with the advertisement to which the control information corresponds, information about participation in a loyalty program associated with the advertisement.

15. A computer program product for use in a wireless communications device, the computer program product comprising:
a non-transitory computer readable medium comprising:
code for causing at least one computer to transmit discovery information including an identifier; and
code for causing said at least one computer to transmit control information corresponding to said identifier.

16. A wireless communications device comprising:
at least one processor configured to:
transmit discovery information including an identifier; and
transmit control information corresponding to said identifier; and
memory coupled to said at least one processor.

17. The wireless communications device of claim 16, wherein said identifier relates to one of: an advertisement, an advertiser or a store.

18. The wireless communications device of claim 17, wherein said control information includes information used by a receiving device to determine an amount bid for display of the advertisement corresponding to said control information.

19. The wireless communications device of claim 18, wherein said control information includes information used to vary an amount of a bid depending on various factors known to the device determining the ad display bid amount at the time the bid is computed.

20. The wireless communications device of claim 19, wherein said factors includes at least one of: geographic location of the device, proximity to a store associated with the advertisement to which the control information corresponds, information about participation in a loyalty program associated with the advertisement.
